(19) United States
(12) Patent Application Publication
(10) Pub. No.: US 2007/0037608 A1
(43) Pub. Date: Feb. 15, 2007

(54) Arrangement comprising a mobile telephone and an auxiliary memory

(76) Inventors: Michael Van Dievoet, Rhode Saint-Genese (BE); Edouard Nicolas Blieck, Rhode Saint-Genese (BE)

Correspondence Address: JACOBSON HOLMAN PLLC, 400 SEVENTH STREET N.W., SUITE 600, WASHINGTON, DC, 20004, US

(21) Appl. No.: 10/552,624

(22) PCT Filed: Mar. 31, 2004
(86) PCT No.: PCT/BE04/00046

§ 371 Date: Sep. 18, 2006

(30) Foreign Application Priority Data
Apr. 9, 2003 (BE) 2003/0229

(51) Int. Cl. H04B 1/38

(52) U.S. Cl. 455/573

(57) ABSTRACT

Assembly comprising a mobile telephone supplied by a self-contained power source, an auxiliary memory and a charger arranged to charge the power source, the said telephone being provided with a memory arranged to store therein data of the operator and data introduced by an owner of the telephone. The loading of the data stored in the memory of the telephone to the auxiliary memory is carried out on the basis of the detection of a charging of the power source.

This is a nationalization of PCT/BE04/000046 filed Mar. 31, 2004 and published in French.

The present invention concerns an assembly comprising a mobile telephone supplied by a self-contained power source, an auxiliary memory and a charger arranged so as to charge the power source, the said telephone being provided with a memory arranged so as to store therein data of the operator and data introduced by an owner of the telephone, the said memory and auxiliary memory being in each case equipped with a read and write device for allowing reading and writing of data in the respective memory. The auxiliary memory is associated with the charger, the said charger being provided with initialisation means connected to the said read and write devices, the said initialisation means being arranged so as to detect a charging of the power source and produce an initialisation signal after detection of such a charging.

Such an assembly is known from the patent U.S. Pat. No. 5,689,825. This patent describes a device and method for downloading software into a portable telephone. This downloading takes place simultaneously with the charging of the telephone battery. The software to be downloaded is situated in a server which is connected to a charging unit. In the known assembly there is a first charger connected to the public network and a second charger which forms part of the portable telephone. The user must therefore connect his telephone to the particular charger in order to download the software.

Such an assembly is also known from the Japanese patent application No 10243463. According to the known assembly, the auxiliary memory is housed in a box which also comprises a connector enabling the mobile telephone to be connected thereto by means of its connection pins. The auxiliary memory serves to copy therein the data which are stored in the telephone memory. Thus the owner of the telephone has a copy of the data stored in the memory of his telephone, which enables him to recover these data in the case where, for any reason, he is no longer in possession of the telephone and/or of the data stored in the telephone memory.

One drawback of the known assembly is that it is the owner himself who must take the initiative to connect his mobile telephone to the box in order to allow copying of the data into the auxiliary memory. Not only is there a risk of the owner forgetting to launch the copying by connecting the telephone to the box, the consequence of which is that the content of the auxiliary memory is not regularly updated, but the owner is also obliged to take the box with him, for example when he sets off on a journey, if he desires regular updating of the auxiliary memory.

The aim of the invention is to produce an assembly comprising a portable telephone and an auxiliary memory where the loading of the auxiliary memory takes place automatically and regularly.

To this end an assembly according to the invention is characterised in that the initialisation means are arranged so as to activate the read device of the memory and the write device of the auxiliary memory under the control of the initialisation signal in order to read the data of the memory and to write in the auxiliary memory at least those data of the memory which are not yet recorded in the auxiliary memory. Since the power source must regularly be charged by means of the charger, detecting a charging and producing an initialisation signal after the detection of such a charging will make it possible to produce an initialisation signal regularly. Since it is the initialisation signal which activates both the read device of the memory of the telephone and the write device of the auxiliary memory, reading the data stored in the memory and writing these data read will take place regularly and automatically, thus allowing regular updating of the auxiliary memory. In addition, since the auxiliary memory and the initialisation means are associated with the charger, the owner will take them with him when he takes his charger, thus no longer requiring taking a separate box.

Certainly the patent U.S. Pat. No. 5,689,825 describes the association of a memory and charger and a coupling of a downloading of software with the action of charging the telephone battery. However, in this US patent it is always the user who must take the initiative to connect his telephone to the charger before the downloading of the new software is initiated. Even if a person skilled in the art finds in this patent the teaching to couple a memory with a charger and to associate the charging of the battery with a downloading of software, nothing for all that in this US patent teaches a person skilled in the art to use the charging of the battery for reading the content of the SIM card and thus to procure a backup of the content of the SIM card. Contrary to the teaching of the US patent, the problem to be solved is not that of operational software which must be updated but that of providing a possibility of having a backup of the content of the SIM card.

The invention also concerns an assembly comprising a mobile telephone, a computer provided with a first memory and a communication module arranged so as to establish data communication between the telephone and the computer, the said telephone being provided with a second memory arranged to store therein data of the operator and data introduced by an owner of the telephone, the said first and second memories being in each case equipped with a read and write device to allow the reading and writing of data in the respective memory, the communication module being provided with initialisation means connected to the said read and write devices, the said initialisation means being arranged so as to detect activation of the communication module and produce an initialisation signal after detection of such an activation. The initialisation means are arranged so as to activate the read device of the memory and the write device of the auxiliary memory under the control of the initialisation signal in order to read the data of the memory and to write in the auxiliary memory at least those data of the memory which are not yet recorded in the auxiliary memory.

Such an assembly is characterised in that the initialisation means are arranged so as to activate the read device of the second memory and the write device of the first memory under the control of the initialisation signal in order to read the data of the second memory and to write in the first memory at least those data of the second memory which are not yet recorded in the first memory. This assembly is distinguished from the previous assembly in that it is not the charging of the power source but the activation of the communication module which triggers the process of copying data from the memory of the computer which then fulfils the same role as the auxiliary memory in the assembly cited initially. Since the communication between the telephone and the computer takes place regularly, a regular update of the first memory will also be obtained.

A first preferential embodiment of an assembly according to the invention is characterised in that an identification code is stored in the memories and in that the initialisation means comprise a verification element arranged so as to compare, under the control of the initialisation signal, the codes stored in the memories and the auxiliary memory or respectively the first and second memories and to produce a neutralisation signal in the case of a non-match of the identification codes compared with each other, the said activation of the read and write device being neutralised under the control of the neutralisation signal. This identification code is for example the PIN or PUK code allocated to the SIM card. The presence of the verification element makes it possible to verify whether the memories concerned do indeed bear the same identification code. If such is not the case, this means that the auxiliary memory or the first memory are not those where the copy is normally stored. Copying the data consequently makes no sense and the neutralisation signal will be produced in order to neutralise the activation of the read and write device and thus to prevent copying the data.

A second preferential embodiment of an assembly according to the invention is characterised in that the initialisation means are arranged so as to activate the read device of the auxiliary memory or respectively of the first memory under the control of the initialisation signal in order to read the data of these memories, the said initialisation means comprising a comparator arranged so as to receive data read in the respective memories, after activation of the read devices, and to compare with each other the data stored in the first and second memories or respectively the memory and the auxiliary memory and to mark on the basis of the comparison the data of the second memory or respectively of the memory which are not stored in the first memory or respectively the auxiliary memory and to store in the first memory or respectively the auxiliary memory only the data marked. Comparison of the data thus makes it possible to store in the auxiliary memory or the first memory only those data which were not yet stored therein.

A third preferential embodiment of an assembly according to the invention is characterised in that the initialisation means are provided with a counter having an input for receiving the initialisation signal, the said counter being arranged to increment a counting amount after reception of the initialisation signal and to produce a counting signal when the counting level has reached a predetermined threshold and a stop signal when this counting level has not reached the said threshold, the said initialisation means being arranged to neutralise the said activation of the read and write devices under the control of the stop signal and to initialise the counting level under the control of the counting signal. This embodiment is advantageous for mobile telephone owners who only occasionally modify the content of the telephone memory. By performing the write operation in the auxiliary memory or the first memory only after having reached a predetermined number of chargings, the number of data transfers is limited.

Preferably, the initialisation means are provided with a transmitter arranged to transmit a message indicating a writing in the auxiliary memory or respectively the first memory when data are written in these. The user is thus warned that the writing operation is underway.

A fourth preferential embodiment of an assembly according to the invention is characterised in that the initialisation means comprise an activation key which can be activated by a user, the said activation key being arranged to produce an activation signal after having been activated, the said write devices of the memory or of the second memory and the said read devices of the auxiliary memory or the first memory being able to be activated under the control of the activation signal in order to allow writing in the memory or the second memory of the data read in the auxiliary memory or the first memory. Activation of the said key thus makes it possible to transfer the data saved in the auxiliary memory or the first memory to that of the telephone and thus to recover the data saved.

The invention will now be described in more detail with the help of the drawings, which set out example embodiments of an assembly according to the invention. In the drawings:

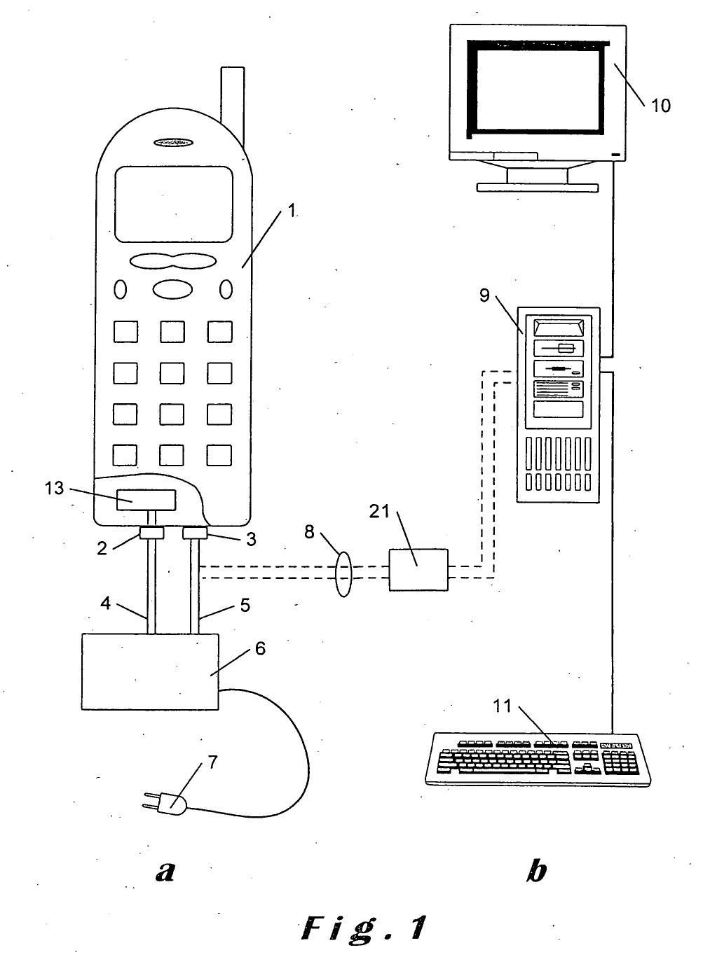

FIGS. 1a+b illustrate both the embodiment where the assembly comprises a charger and that where the assembly comprises a computer and a communication module;

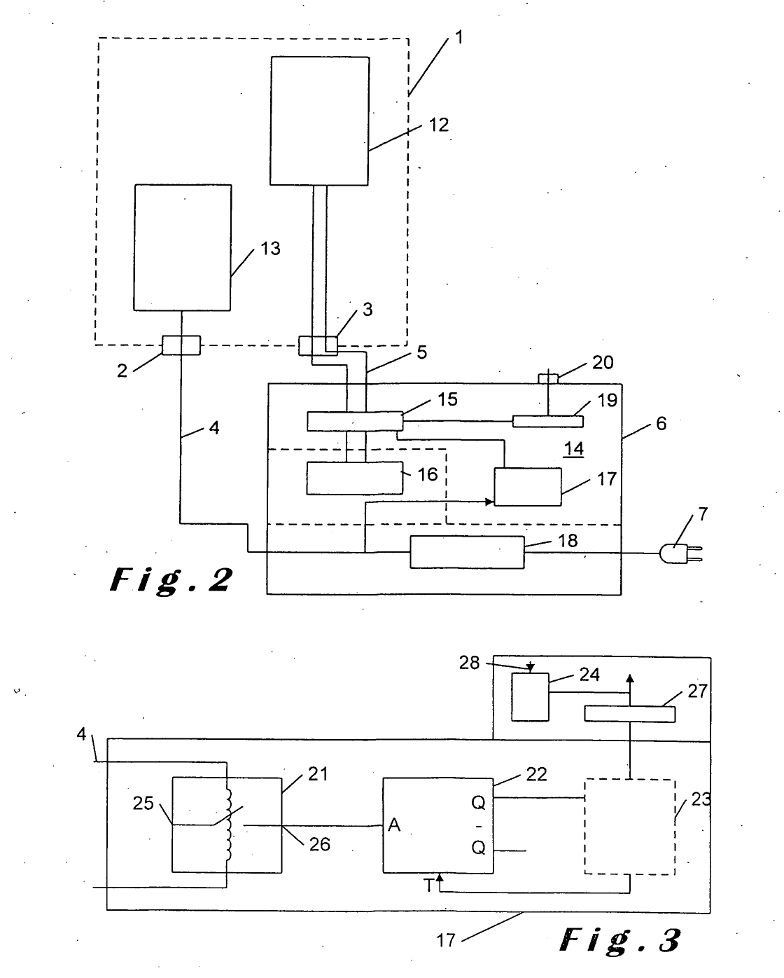

FIG. 2 illustrates details of the initialisation means connected to the telephone memory and to the power source;

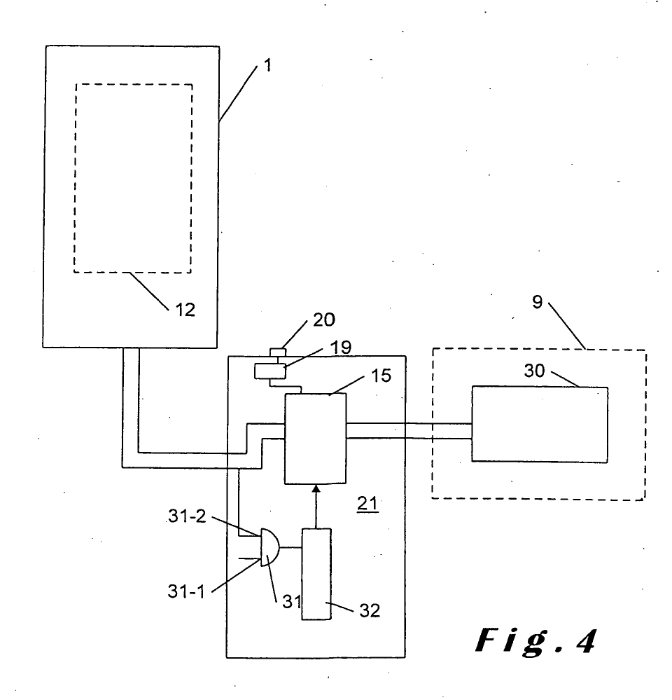

FIG. 3 illustrates an example embodiment of a detector forming part of the initialisation means; and

FIG. 4 illustrates the communication module connected to the first and second memories.

In the drawings the same reference has been allocated to the same element or a similar element.

The assembly illustrated in FIG. 1a comprises a mobile telephone 1 provided with a first connection pin 2 forming an electric current supply input for charging the self-contained power source 13, generally formed by a rechargeable battery. The first pin 2 is connected by means of a wire 4 to a charger 6 arranged to charge the power source 13. The charger also has a wire provided with a plug 7 for connecting the charger to an electrical system. A second pin 3 forms a data exchange interface.

The assembly illustrated in FIG. 1b is distinguished from that illustrated in FIG. 1a in that in place of the charger there is a computer 9 and a communication module 21 arranged to establish a data communication between the telephone and the computer. The latter preferably being equipped with a keyboard 11 and a display screen 10.

The charger 6 is generally provided with a transformer/converter 18, as illustrated in FIG. 2, the said transformer/converter being arranged to transform the alternating current supplied by the system into a low-voltage DC current. The latter is then supplied to the power source 13 in order to charge it.

In the example embodiment illustrated in FIG. 2, the charger is provided with initialisation means 14. The latter can be connected to the memory 12 of the telephone 1 by means of the connection 5, which can be connected to the second pin 3. The charger 6 is also associated with an auxiliary memory 16. The initialisation means and the auxiliary memory 16 are preferably incorporated in the same box as that which comprises the transformer/converter of the charger. Naturally separate housings can also be envisaged for these various components.

The memory 12 of the telephone is preferably formed by the SIM card and/or by a memory of the telephone arranged so as to store therein data of the operator and data introduced by the owner of the telephone. The data are for example the PIN and PUK code, telephone numbers introduced by the owner, images to be displayed on the telephone screen or other date peculiar to the owner and which he wishes to store. The auxiliary memory 16 is also arranged to store therein the same data as those stored in the memory 12 of the telephone. In order to be able to read and write data in the memories 12 and 16, the latter are each equipped with a read device and a write device (not shown in the drawings).

The initialisation means are arranged to detect a charging of the power source 13 and to produce an initialisation signal after detection of such a charging. For this purpose they comprise a detector 17 having an input connected to the output of the transformer/converter 18. An example embodiment of such a detector is illustrated in FIG. 3. The detector comprises a relay 21 whose excitation input is connected to the line 4 leaving the transformer/converter. A current input 25 of the relay is connected to a current supply source which, where applicable, may be the line 14. A current output 26 of the relay is connected to an input A of a flip-flop 22, an output Q of which is connected to an input of a counter 23. It should however be noted that the counter 23 is optional. This counter is arranged to count to a predetermined counting level and to be reset to zero or initialised when the said counting level has been reached. An output of the counter is connected to an interface 15 and to a transmitter 24 arranged to transmit a message, as will be described in more detail below.

The interface 15 comprises a buffer which, where necessary, can be provided with a data comparator and a logic management unit. The interface is located either in the charger box or in the telephone itself. In the latter case, the logic unit can be integrated in the computer of the telephone. The initialisation means also comprise an activation key 20, for example a push button connected to an activation signal generator 19.

Assume now that the data are stored in the memory 12 of the telephone and that the owner will charge the telephone power source. To perform this operation he will connect the wire 4 of the charger in the first pin 2 of the telephone and a plug 7 in an electrical system socket. The charger will thus charge the power source by outputting an electric current which will flow over the line 4. Since the detector 17 is connected to the line 4, the relay 21 will be excited by the current which is supplied to it at its input and will close, thus supplying a signal to the input A of the flip-flop 22. The flip-flop will thus switch and supply a signal to the counter 23, which will be incremented. The incrementation of the counter will produce a signal which will be supplied to the reset input T of the flip-flop 22 in order to reset it to the initial state. If the counter has reached the predetermined threshold it will produce a counting signal which will be supplied to a generator 27 arranged to produce an initialisation signal. If on the other hand the counter has not reached the said threshold a stop signal will be produced which will neutralise the generator 27 and thus the operation of the initialisation means.

Where the counter is not used, the output signal from the flip-flop is directly supplied to the generator 27 and there is no neutralisation occurring. Naturally other embodiments of the detector, for example using logic AND or OR gates, can be envisaged. The use of a counter 23 makes it possible not to have to activate all the operations of the initialisation means each time the power source is charged.

Assume now that the generator 27 has produced the initialisation signal. The latter is then supplied to the interface 15, which will be activated under the control of the initialisation signal. When the interface is not equipped with a comparator, it will delete the content of the auxiliary memory 16 and activate the read device of the memory 12 in order to read the data stored in the latter. The data read are temporarily stored in the interface 15, which will also activate the write device of the auxiliary memory. When this write device is activated, the data coming from the memory 12 will be written in the auxiliary memory 16. Thus the data stored in the memory 12 of the telephone will be copied into the auxiliary memory 16.

When the interface 15 is equipped with a comparator, the initialisation signal will not only activate the device reading the memory 12 but also that of the memory 16 in order also to read the data stored in the latter memory. The comparator will then receive the data read in the two memories and will compare them with each other in order to verify which of the data stored in the memory 12 are not yet stored in the auxiliary memory 16. Thus the comparator will mark, on the basis of the. comparison, the data which are not yet copied into the auxiliary memory. Only the data thus marked will then be stored in the auxiliary memory. This avoids having on each occasion to empty all the auxiliary memory 16 and on each occasion to copy all the data in the memory 12 into the auxiliary memory 16.

In order to indicate to the owner of the telephone that a write operation is being performed in the auxiliary memory, the transmitter 24 will transmit a message. To this end the transmitter receives not only the initialisation signal, through its connection with the output of the generator 27, but also at its input 28 the signal which activates the write device of the auxiliary memory 16. Thus, as long as the writing is under way in the auxiliary memory, the transmitter will transmit a message. Thus the owner is warned that a writing has taken place in the auxiliary memory and therefore that he must not disconnect the charger, otherwise the writing operation is disturbed through lack of current supply.

The transmitter can comprise a siren emitting an audible signal, or can be connected to the screen of the telephone in order to display thereon a message for example in the form of an icon or a written message. According to another alternative the transmitter comprises an indicator light located on the box.

The purpose of copying into the auxiliary memory the data contained in the memory 12 of the telephone is naturally to be able, when necessary, to copy them into the memory 12 for example in the case of loss of the telephone. When the user wishes to copy the data stored in the auxiliary memory 16 he will activate the activation key 20 in order to activate the generator 19, which will then produce an activation signal. The interface 15, which will receive the activation signal, will, under the control of the latter signal, activate the read device of the auxiliary memory and the write device of the memory 12 of the telephone. Thus the data stored in the auxiliary memory 16 will be read and then written in the memory 12. The latter will thus once again be provided with the data necessary for its operation.

In order to prevent the writing in the auxiliary memory 16 taking place solely in an auxiliary memory which belongs to the owner, it is preferable to store in the auxiliary memory the identification code, for example the PIN and/or PUK code of the SIM card. Thus it is possible to compare, for example by means of the comparator included in the interface 15, the identification codes stored in the memories 12 and 16. This comparison will be made under the control of the initialisation signal. If the codes of the two memories correspond, the writing can take place in the auxiliary memory. In the contrary case the read and write device of the memories will not be activated or neutralised by a neutralisation signal produced by the comparator following a negative comparison. Thus, when the owner charges his telephone with a charger which is not his own, it is avoided having the content of the memory of his telephone being copied into an auxiliary memory which does not belong to him.

FIG. 4 illustrates the communication module 21 connected to a first memory 30 of the computer 9 and a second memory 12 of the telephone. The first memory 30 has a function similar to that of the auxiliary memory 16 described in the example embodiment which has just been described, namely storing a copy of the data stored in the second memory 12 of the telephone. Given that the operating mode of this embodiment is similar to that which has just been described, only the specific differences will be described. Thus the data and/or identification code comparison functions, the use of a counter and the transmission of a message are similar and will consequently not be described again in detail for this embodiment. The interface 15 is located either in the telephone or in the computer itself. In the latter case, the logic unit of the interface is preferably integrated in that of the computer.

The communication module 21 comprises the initialisation means which are for example formed by a logic AND gate 31 connected to an initialisation signal generator 32 which for its part is connected to an interface 15. The logic gate in its turn receives as an input 31-1 a fixed signal with a logic “1” value. The other input 31-2 of the logic gate receives a call signal coming from the telephone indicating that a communication with the computer is desired. Thus, when the latter signal is received, the generator 32 is activated, thus producing an initialisation signal which is supplied to the interface 15, which will then activate the read device of the second memory 12 and the write device of the first memory as described previously.

Some mobile telephones also have a diary function. It goes without saying that, in the latter case, the diary data can also be duplicated in the auxiliary memory or the first memory. Where applicable it would even be possible to copy only the data from the diary should the diary not have the telephone function. The data would then be copied in a similar fashion to that which has just been described.

1. Assembly comprising a mobile telephone supplied by a self-contained power source, an auxiliary memory and a charger arranged so as to charge the power source, the said telephone being provided with a memory arranged to store therein the data of the operator and data introduced by an owner of the telephone, the said memory and auxiliary memory in each case being equipped with a read and write device to allow the reading and writing of data in the respective memory, the auxiliary memory being associated with the charger, the said charger being provided with initialisation means connected to the said read and write devices, the said initialisation means being arranged to detect a charging of the power source and produce an initialisation signal after detection of such a charging, characterised in that the initialisation means are arranged to activate the read device of the memory and the write device of the auxiliary memory under the control of the initialisation signal in order to read the data of the memory and to write in the auxiliary memory at least these data of the memory which are not yet recorded in the auxiliary memory.

2. Assembly comprising a mobile telephone, a computer provided with a first memory and a communication module arranged to establish a communication of data between the telephone and the computer, the said telephone being provided with a second memory arranged to store therein data of the operator and data introduced by an owner of the telephone, the said first and second memories in each case being equipped with a read and write device for allowing the reading and writing of data in the respective memory, the communication module being provided with initialisation means connected to the said read and write devices, the said initialisation means being arranged to detect an activation of the communication module and to produce an initialisation signal after detection of such an activation, characterised in that the initialisation means are arranged to activate the read device of the second memory and the write device of the first memory under the control of the initialisation signal in order to read the data of the second memory and write in the first memory at least those data of the second memory which are not yet recorded in the first memory.

3. Assembly according to claim 1, characterised in that an identification code is stored in the memories and in that the initialisation means comprise a verification element arranged to compare, under the control of the initialisation signal, the codes stored in the memory and the auxiliary memory or respectively the first and second memory in order to produce a neutralisation signal in the event of a non-match of the identification codes compared with each other, the said activation of the read and write device being neutralised under the control of the neutralisation signal.

4. Assembly according to claim 1, characterised in that the initialisation means are arranged so as to activate the read device of the auxiliary memory or respectively of the first memory under the control of the initialisation signal in order to read the data of these memories, the said initialisation means comprising a comparator arranged so as to receive data read in the respective memories, after activation of the read devices, and to compare with each other the data stored in the first and second memories or respectively the memory and the auxiliary memory and to mark on the basis of the comparison the data of the second memory or respectively of the memory which are not stored in the first memory or respectively the auxiliary memory and to store in the first memory or respectively the auxiliary memory only the data marked.

5. Assembly according to claim 1, characterised in that the initialisation means are arranged to delete the content of the auxiliary memory or respectively the first memory under the control of the initialisation signal.

6. Assembly according to claim 1, characterised in that the initialisation means are provided with a counter having an input for receiving the initialisation signal, the said counter being arranged to increment a counting amount after reception of the initialisation signal and to produce a counting signal when the counting level has reached a predetermined threshold and a stop signal when this counting level has not reached the said threshold, the said initialisation means being arranged to neutralise the said activation of the read and write devices under the control of the stop signal and to initialise the counting level under the control of the counting signal.

7. Assembly according to claim 1, characterised in that the initialisation means are provided with a transmitter arranged to transmit a message indicating a writing in the auxiliary memory or respectively the first memory when data are written in these.

8. Assembly according to claim 1, characterised in that the initialisation means comprise an activation key which can be activated by a user, the said activation key being arranged to produce an activation signal after having been activated, the said write devices of the memory or of the second memory and the said read devices of the auxiliary memory or the first memory being able to be activated under the control of the activation signal in order to allow writing in the memory or the second memory of the data read in the auxiliary memory or the first memory.

9. Assembly according to claim 1, characterised in that the initialisation means comprise a connection pin connected to a conductive wire itself connected to the auxiliary memory, the said pin being compatible with that of the telephone giving access to the memory.

10. Initialisation means to be used in an assembly according to claim 1.
